(19) United States
(12) Patent Application Publication
(10) Pub. No.: US 2023/0128747 A1
(43) Pub. Date: Apr. 27, 2023

(54) SOLID STATE BATTERY

(71) Applicant: Murata Manufacturing Co., Ltd., Nagaokakyo-shi (JP)

(72) Inventors: Keisuke SHIMIZU, Nagaokakyo-shi (JP); Takuro HIRAKIMOTO, Nagaokakyo-shi (JP); Sumito SHIINA, Nagaokakyo-shi (JP)

(21) Appl. No.: 18/069,312

(22) Filed: Dec. 21, 2022

Related U.S. Application Data
(63) Continuation of application No. PCT/JP2021/024591, filed on Jun. 29, 2021.

(30) Foreign Application Priority Data
Jul. 1, 2020 (JP) 2020-114383

(51) Int. Cl. H01M 10/0562; H01M 50/284; H01M 50/141

(52) U.S. Cl. CPC H01M 10/0562; H01M 50/284; H01M 50/141

(57) ABSTRACT

A solid state battery that includes a solid state battery laminate including a positive electrode layer, a negative electrode layer, and a solid electrolyte layer interposed between the positive electrode layer and the negative electrode layer; and a member surrounding or in contact with the solid state battery, the member containing a moisture absorbing material.

### CROSS REFERENCE TO RELATED APPLICATIONS

The present application is a continuation of International application No. PCT/JP2021/024591, filed Jun. 29, 2021, which claims priority to Japanese Patent Application No. 2020-114383, filed Jul. 1, 2020, the entire contents of each of which are incorporated herein by reference.

### FIELD OF THE INVENTION

The present invention relates to a solid state battery packaged to be suitable for board mounting.

### BACKGROUND OF THE INVENTION

Conventionally, secondary batteries that can be repeatedly charged and discharged have been used for various purposes. For example, the secondary battery is used as a power supply of an electronic device such as a smartphone and a notebook computer.

In the secondary battery, a liquid electrolyte is generally used as a medium for ion transfer that contributes to charge and discharge. That is, a so-called electrolytic solution is used for the secondary battery. However, in such a secondary battery, safety is generally required in terms of preventing leakage of an electrolytic solution. Furthermore, since an organic solvent or the like used for the electrolytic solution is a flammable substance, safety is also required in that respect.

Therefore, a solid state battery configured using a solid electrolyte instead of an electrolytic solution has been studied.

Patent Document 1: Japanese Patent Application Laid-Open No. 2000-243357

### SUMMARY OF THE INVENTION

The inventors of the present application have noticed that there is a problem to be overcome in the conventional secondary battery, and have found a need to take measures therefor. Specifically, the inventors of the present application have found that there are the following problems.

It is conceivable that the solid state battery is used by being mounted on a board such as a printed wiring board together with other electronic components, and in that case, a battery suitable for mounting is required. On the other hand, the solid state battery needs to take necessary measures against moisture in the air. This is because when moisture enters the inside of the solid state battery, there is a possibility that battery characteristics are deteriorated.

Here, Patent Document 1 discloses a secondary battery in which a positive electrode material and a negative electrode material electrically coupled to a current collector are laminated with a non-flowable electrolyte layer interposed therebetween, and a battery element containing an ionic metal component and a moisture absorbent are sealed with a synthetic resin housing. Furthermore, Patent Document 1 also discloses that the moisture absorbent is added to the inside of the housing or a synthetic resin layer of the housing.

However, in the secondary battery disclosed in Patent Document 1, moisture may enter from a gap between the moisture absorbent and the secondary battery, and it is hard to say that the secondary battery is a solid state battery in which moisture entry is sufficiently prevented.

The present invention has been made in view of such problems. That is, a main object of the present invention is to provide a technique of a solid state battery that reduces entry of moisture into the solid state battery while considering mounting on a board.

The inventors of the present application have attempted to solve the above problems by addressing the problems in a new direction instead of addressing the problems in an extension of the conventional technique. As a result, the present inventors have reached the invention of a solid state battery in which the above main object has been achieved.

A solid state battery according to the present invention is a solid state battery comprising: a solid state battery laminate including a positive electrode layer, a negative electrode layer, and a solid electrolyte layer interposed between the positive electrode layer and the negative electrode layer; and a member surrounding or in contact with the solid state battery, the member containing a moisture absorbing material.

The solid state battery according to the present invention can reduce entry of moisture into the solid state battery.

More specifically, in the packaged solid state battery of the present invention, since the moisture absorbing material is mixed into the constituent elements of the solid state battery, moisture in the solid state battery can be absorbed without separately providing a member for absorbing moisture. Therefore, it is possible to reduce entry of moisture into the solid state battery.

Furthermore, since the moisture absorbing material is mixed into the constituent elements of the solid state battery, an increase in volume of the solid state battery laminate can be suppressed. Therefore, downsizing of the package can be realized without reducing the energy density per volume of the solid state battery.

### BRIEF EXPLANATION OF THE DRAWINGS

FIG. 1(a) is a side sectional view schematically illustrating a solid state battery according to an embodiment of the present invention, and FIG. 1(b) is a side sectional view schematically illustrating a solid state battery according to another embodiment of the present invention.

FIG. 2 is a side sectional view schematically illustrating a solid state battery according to another embodiment of the present invention.

FIG. 3(a) is a side sectional view schematically illustrating a solid state battery according to another embodiment of the present invention, and FIG. 3(b) is a side sectional view schematically illustrating a solid state battery according to another embodiment of the present invention.

FIG. 4(a) is a side sectional view schematically illustrating a solid state battery according to another embodiment of the present invention, and FIG. 4(b) is a side sectional view schematically illustrating a solid state battery according to another embodiment of the present invention.

FIG. 5(a) is a side sectional view schematically illustrating a solid state battery according to another embodiment of the present invention, and FIG. 5(b) is a side sectional view schematically illustrating a solid state battery according to another embodiment of the present invention.

FIG. 6(a) is a side sectional view schematically illustrating a configuration of a solid state battery according to another embodiment of the present invention (a sectional view taken along line VIA-VIA in FIG. 6(b)).

FIG. 6(b) is a sectional view taken along line VIB-VIB of FIG. 6(a).

FIGS. 7(a) to 7(d) are process sectional views (side sectional views) illustrating a manufacturing flow of the solid state battery according to the embodiment of the present invention.

### DETAILED DESCRIPTION OF THE INVENTION

Hereinafter, a solid state battery of the present invention will be described in detail. Although the description will be made with reference to the drawings as necessary, the illustrated contents are only schematically and exemplarily illustrated for the understanding of the present invention, and the appearance or the dimensional ratio, and the like may be different from the actual ones.

A “packaged solid state battery” referred to in the present invention means a solid state battery protected from an external environment in a broad sense, and refers to a solid state battery in which water vapor from the external environment is prevented from entering the inside of the solid state battery in a narrow sense. The term “water vapor” as used herein refers to moisture typified by water vapor in the atmosphere, and in a preferred aspect, means moisture including not only water vapor in a gas form but also liquid water. In particular, the water in a liquid state may include dew condensation water in which water in a gaseous state is condensed. Preferably, the solid state battery of the present invention in which such moisture permeation is prevented is packaged so as to be suitable for board mounting, particularly packaged so as to be suitable for surface mounting. Therefore, in a preferred aspect, the battery of the present invention is a surface mount device (SMD) type battery. Note that the term “water vapor” used in the present specification may also be referred to as “moisture” or the like.

The “solid state battery” referred to in the present invention refers to a battery whose constituent elements are solid in a broad sense, and refers to an all-solid state battery whose constituent elements (particularly preferably all constituent elements) are solid in a narrow sense. In a preferred aspect, the solid state battery in the present invention is a laminated solid state battery configured such that layers constituting a battery constituent unit are laminated with each other, and preferably each of such layers is composed of a sintered body. Note that the “solid state battery” includes not only a so-called “secondary battery” capable of repeating charging and discharging but also a “primary battery” capable of only discharging. According to a preferred aspect of the present invention, the “solid state battery” is a secondary battery. The “secondary battery” is not excessively limited by its name, and may include, for example, a power storage device and the like. Note that the term “sintering” as used in the present invention is only required to achieve sintering at least in part.

A term “side surface section” as used in the present specification is based on a form (to put it briefly, a form in the case of being cut along a plane parallel to a thickness direction) when viewed from a direction substantially perpendicular to a thickness direction based on a lamination direction of each layer constituting the solid state battery. An “up-down direction” and a “left-right direction” used directly or indirectly in the present specification correspond to an up-down direction and a left-right direction in the drawings, respectively. Unless otherwise specified, the same reference symbols or signs indicate the same members/parts or the same semantic contents. In a preferred aspect, a downward direction in a vertical direction (that is, a direction in which gravity acts) corresponds to a “downward direction”, and an opposite direction thereof corresponds to an “upward direction”.

A term “top surface” as used in the present specification means a surface positioned on a relatively upper side among surfaces constituting the battery, and a term “bottom surface” means a surface positioned on a relatively lower side among surfaces constituting the battery. Assuming a typical solid state battery having two opposing principal surfaces, a term “top surface” as used in the present specification refers to one of the principal surfaces, and a term “bottom surface” refers to the other of the principal surfaces.

Hereinafter, first, a basic configuration of the solid state battery of the present invention will be described. The configuration of the solid state battery described here is merely an example for understanding the invention, and does not limit the invention.

[Basic Configuration of Solid State Battery]

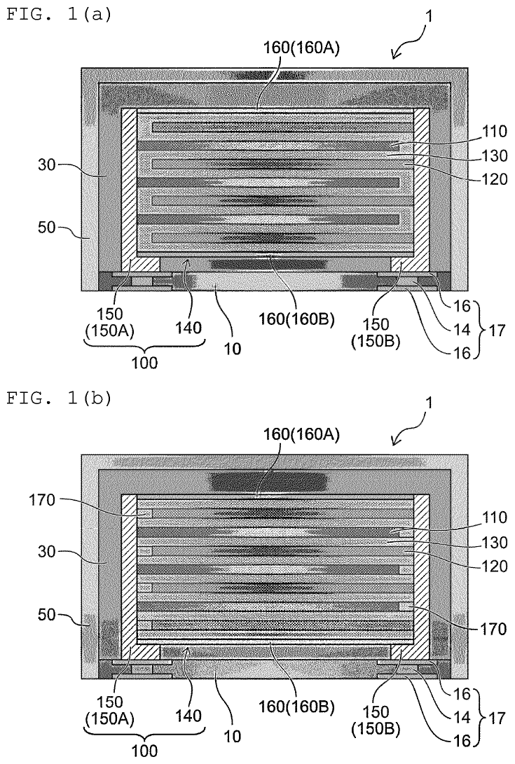

A solid state battery 1 includes a solid state battery laminate 100 (FIG. 1(a)), and the solid state battery laminate 100 includes a laminated part 140 including a battery constituent unit including a positive electrode layer 110, a negative electrode layer 120, and a solid electrolyte 130 interposed therebetween. The solid state battery laminate 100 is supported by a support board. Moreover, the solid state battery 1 may include a covering insulating film 30 that covers the solid state battery laminate 100, and a covering inorganic film 50 that covers the covering insulating film 30.

Each layer constituting the laminated part 140 is formed by firing, and the positive electrode layer, the negative electrode layer, the solid electrolyte, and the like may form a sintered layer. Preferably, the positive electrode layer, the negative electrode layer, and the solid electrolyte are each fired integrally with each other, and therefore the laminated part may form an integrally sintered body. Note that, in the present specification, a direction (vertical direction) in which the positive electrode layer and the negative electrode layer are laminated is referred to as a “lamination direction”, and a direction intersecting the lamination direction is a horizontal direction in which the positive electrode layer and the negative electrode layer extend.

(Positive Electrode Layer and Negative Electrode Layer)

The positive electrode layer 110 is an electrode layer containing at least a positive electrode active material. The positive electrode layer may further contain a solid electrolyte. In a preferred aspect, the positive electrode layer is composed of a sintered body containing at least positive electrode active material particles and solid electrolyte particles. On the other hand, the negative electrode layer 120 is an electrode layer containing at least a negative electrode active material. The negative electrode layer may further contain a solid electrolyte. In a preferred aspect, the negative electrode layer is composed of a sintered body containing at least negative electrode active material particles and solid electrolyte particles. FIG. 1(a) illustrates a configuration in which three positive electrode layers 110 and four negative electrode layers 120 are laminated, but the number of laminated layers is not limited to this example, and several tens to several hundreds of layers may be laminated. A film thickness of the positive electrode layer or the negative electrode layer may be 5 μm to 60 μm, and preferably 8 μm to 50 μm. Furthermore, the thickness may be 5 μm to 30 μm.

The positive electrode active material and the negative electrode active material are substances involved in the transfer of electrons in the solid state battery. Ions move (conduct) between the positive electrode layer and the negative electrode layer via the solid electrolyte, and electrons are transferred, whereby charging and discharging are performed. The positive electrode layer and the negative electrode layer are particularly preferably layers capable of occluding and releasing lithium ions or sodium ions. That is, the solid state battery is preferably an all-solid state secondary battery in which lithium ions or sodium ions move between the positive electrode layer and the negative electrode layer via the solid electrolyte to charge and discharge the battery.

(Positive Electrode Active Material)

Examples of the positive electrode active material contained in the positive electrode layer include at least one selected from the group consisting of a lithium-containing phosphate compound having a NASICON-type structure, a lithium-containing phosphate compound having an olivine-type structure, a lithium-containing layered oxide, a lithium-containing oxide having a spinel-type structure, and the like. Examples of the lithium-containing phosphate compound having a NASICON-type structure include Li₃V₂(PO₄)₃. Examples of the lithium-containing phosphate compound having an olivine-type structure include Li₃Fe₂(PO₄)₃, LiFePO₄, and LiMnPO₄. Examples of the lithium-containing layered oxide include LiCoO₂ and LiCo_{1/3}Ni_{1/3}Mn_{1/3}O₂. Examples of the lithium-containing oxide having a spinel-type structure include LiMn₂O₄ and LiNi_{0.5}Mn_{1.5}O₄. The type of the lithium compound is not particularly limited, and may be, for example, a lithium transition metal composite oxide and a lithium transition metal phosphate compound. The lithium transition metal composite oxide is a generic term for oxides containing lithium and one or more kinds of transition metal elements as constituent elements, and the lithium transition metal phosphate compound is a generic term for phosphate compounds containing lithium and one or more kinds of transition metal elements as constituent elements. The kind of the transition metal element is not particularly limited, and examples thereof include cobalt (Co), nickel (Ni), manganese (Mn), and iron (Fe).

Furthermore, examples of the positive electrode active material capable of occluding and releasing sodium ions include at least one selected from the group consisting of a sodium-containing phosphate compound having a NASICON-type structure, a sodium-containing phosphate compound having an olivine-type structure, a sodium-containing layered oxide, a sodium-containing oxide having a spinel-type structure, and the like. For example, in the case of a sodium-containing phosphate compound, at least one selected from the group consisting of Na₃V₂(PO₄)₃, NaCoFe₂(PO₄)₃, Na₂Ni₂Fe(PO₄)₃, Na₃Fe₂(PO₄)₃, Na₂FeP₂O₇, Na₄Fe₃(PO₄)₂(P₂O₇), and NaFeO₂ as a sodium-containing layered oxide can be mentioned.

In addition, the positive electrode active material may be, for example, an oxide, a disulfide, a chalcogenide, a conductive polymer, or the like. The oxide may be, for example, titanium oxide, vanadium oxide, manganese dioxide, or the like. The disulfide is, for example, titanium disulfide or molybdenum sulfide. The chalcogenide may be, for example, niobium selenide. The conductive polymer may be, for example, disulfide, polypyrrole, polyaniline, polythiophene, polypara-styrene, polyacetylene, or polyacene.

(Negative Electrode Active Material)

Examples of the negative electrode active material contained in the negative electrode layer include at least one selected from the group consisting of an oxide containing at least one element selected from the group consisting of Ti, Si, Sn, Cr, Fe, Nb, and Mo, a carbon material such as graphite, a graphite-lithium compound, a lithium alloy, a lithium-containing phosphate compound having a NASICON-type structure, a lithium-containing phosphate compound having an olivine-type structure, and a lithium-containing oxide having a spinel-type structure, and the like. Examples of the lithium alloy include Li—Al. Examples of the lithium-containing phosphate compound having a NASICON-type structure include Li₃V₂(PO₄)₃ and LiTi₂(PO₄)₃. Examples of the lithium-containing phosphate compound having an olivine-type structure include Li₃Fe₂(PO₄)₃ and LiCuPO₄. Examples of the lithium-containing oxide having a spinel-type structure include Li₄Ti₅O₁₂.

Furthermore, examples of the negative electrode active material capable of occluding and releasing sodium ions include at least one selected from the group consisting of a sodium-containing phosphate compound having a NASICON-type structure, a sodium-containing phosphate compound having an olivine-type structure, a sodium-containing oxide having a spinel-type structure, and the like.

The positive electrode layer and/or the negative electrode layer may contain a conductive material. Examples of the conductive material contained in the positive electrode layer and the negative electrode layer include at least one kind of metal materials such as silver, palladium, gold, platinum, aluminum, copper, and nickel, carbon, and the like.

Moreover, the positive electrode layer and/or the negative electrode layer may contain a sintering additive. Examples of the sintering additive include at least one selected from the group consisting of aluminum oxide, lithium oxide, sodium oxide, potassium oxide, boron oxide, silicon oxide, bismuth oxide, and phosphorus oxide.

(Solid Electrolyte)

The solid electrolyte 130 is a material capable of conducting lithium ions. In particular, the solid electrolyte 130 constituting a battery constituent unit in the solid state battery forms a layer through which lithium ions can conduct between the positive electrode layer 110 and the negative electrode layer 120. Specific examples of the solid electrolyte include a lithium-containing phosphate compound having a NASICON structure, an oxide having a perovskite structure, an oxide having a garnet-type or garnet-type similar structure, and an oxide glass ceramic-based lithium ion conductor. Examples of the lithium-containing phosphate compound having a NASICON structure include LiₓM_{y}(PO₄)₃ (1≤x≤2, 1≤y≤2, and M is at least one selected from the group consisting of Ti, Ge, Al, Ga, and Zr.). Examples of the lithium-containing phosphate compound having a NASICON structure include Li_{1.2}Al_{0.2}Ti_{1.8}(PO₄)₃. Examples of the oxide having a perovskite structure include La_{0.55}Li_{0.35}TiO₃. Examples of the oxide having a garnet-type or garnet-type similar structure include Li₇La₃Zr₂O₁₂. As the oxide glass ceramic-based lithium ion conductor, for example, a phosphate compound (LATP) containing lithium, aluminum, and titanium as constituent elements, and a phosphate compound (LAGP) containing lithium, aluminum, and germanium as constituent elements can be used. Note that the solid electrolyte may be, for example, a glass electrolyte.

The solid electrolyte layer may contain a sintering additive. The sintering additive contained in the solid electrolyte layer may be selected from, for example, the same materials as the sintering additive that can be contained in the positive electrode layer and the negative electrode layer.

(Positive Electrode Current Collecting Layer and Negative Electrode Current Collecting Layer)

The positive electrode layer 110 and the negative electrode layer 120 may include a positive electrode current collecting layer and a negative electrode current collecting layer, respectively. Each of the positive electrode current collecting layer and the negative electrode current collecting layer may have a form of a foil, but may have a form of a sintered body from the viewpoint of reducing the manufacturing cost of the solid state battery by integral firing and reducing the internal resistance of the solid state battery. Note that, when the positive electrode current collecting layer and the negative electrode current collecting layer have the form of a sintered body, the positive electrode current collecting layer and the negative electrode current collecting layer may be formed of a sintered body containing a conductive material and a sintering additive. The conductive material contained in the positive electrode current collecting layer and the negative electrode current collecting layer may be selected from, for example, the same material as the conductive material that can be contained in the positive electrode layer and the negative electrode layer. The sintering additive contained in the positive electrode current collecting layer and the negative electrode current collecting layer may be selected from, for example, the same materials as the sintering additive that can be contained in the positive electrode layer and the negative electrode layer. Note that, in the solid state battery, the positive electrode current collecting layer and the negative electrode current collecting layer are not essential, and a solid state battery in which such a positive electrode current collecting layer and a negative electrode current collecting layer are not provided is also conceivable. That is, the solid state battery in the present invention may be a solid state battery without a current collecting layer.

(External Terminal)

A pair of external terminals 150 is provided on side surfaces of the laminated part 140 located in a direction intersecting a lamination direction. For example, an external terminal may be provided from a side surface to a bottom surface of the laminated part 140. More specifically, an external terminal 150A on a positive electrode side connected to the positive electrode layer 110 and an external terminal 150B on a negative electrode side connected to the negative electrode layer 120 may be provided, the external terminal 150A on the positive electrode side may be formed on one side surface (in the illustrated example, a left side), and the external terminal 150B on the negative electrode side may be provided (in the illustrated example, a right side) so as to face the external terminal 150A on the positive electrode side. The pair of external terminals 150 is preferably made of a material having high conductivity. A specific material of the external terminal is not particularly limited, but may be at least one selected from the group consisting of silver, gold, platinum, aluminum, copper, tin, and nickel.

(Inactive Substance Part)

An inactive substance part 170 may be provided between the positive electrode layer 110 and the external terminal 150B on the negative electrode side and between the negative electrode layer 120 and the external terminal 150A on the positive electrode side (see FIG. 1(b)). The inactive substance part 170 is provided to insulate between the positive electrode layer 110 and the external terminal 150B on the negative electrode side and between the negative electrode layer 120 and the external terminal 150A on the positive electrode side. That is, the inactive substance part preferably has at least an electronic insulation property. As a material of the inactive substance part, a material conventionally used as the “inactive substance” of the solid state battery may be used, and the inactive substance part may be formed of a resin material, a glass material, and/or a ceramic material. From the viewpoint of manufacturing by firing, it may have the form of a sintered body. Examples thereof include at least one selected from the group consisting of soda lime glass, potassium glass, borate glass, borosilicate glass, barium borosilicate glass, bismuth zinc borate glass, bismuth silicate glass, phosphate glass, aluminophosphate glass, and zinc phosphate glass. Furthermore, although not particularly limited, examples of the ceramic material include at least one selected from the group consisting of aluminum oxide, boron nitride, silicon dioxide, silicon nitride, zirconium oxide, aluminum nitride, silicon carbide, and barium titanate. Note that the inactive substance part can also be referred to as a “margin part” or a “negative part” due to its form.

(Insulating Outermost Layer)

An insulating outermost layer 160 may be provided on the outermost side of the laminated part 140. The insulating outermost layer 160 can be generally formed on an outermost side of the laminated part 140, and is for electrically, physically, and/or chemically protecting the solid state battery laminate. Particularly, the insulating outermost layer 160 includes an insulating outermost layer 160A on a top surface side and an insulating outermost layer 160B on a bottom surface side of the solid state battery laminate 100. A material constituting the insulating outermost layer is preferably excellent in insulation property, durability and/or moisture resistance and is environmentally safe, and may contain, for example, a resin material, a glass material and/or a ceramic material. Moreover, the insulating outermost layer may have the form of a sintered body for manufacturing by integral firing, and may be constituted by a sintered body (for example, silicon oxide) containing a sintering additive that can be contained in the above-described positive electrode layer and negative electrode layer. Note that the top surface and the bottom surface of the solid state battery laminate may be the laminated part 140 without providing the insulating outermost layer 160.

(Covering Insulating Film)

The solid state battery may be provided with the covering insulating film 30 provided so as to cover at least the solid state battery laminate 100. As illustrated in FIGS. 1(a) and 1(b), the solid state battery laminate 100 provided on a support board 10 is largely wrapped by the covering insulating film 30 as a whole.

The covering insulating film 30 preferably corresponds to a resin. That is, it is preferable that the covering insulating film 30 includes a resin material, and the resin material forms a base material. As can be seen from the aspect illustrated in FIGS. 1(a) and 1(b), this means that the solid state battery laminate 100 provided on the support board 10 is sealed with a resin material of the covering insulating film 30. The covering insulating film 30 made of such a resin material suitably contributes to reduction of entry of moisture in combination with the covering inorganic film 50.

A material of the covering insulating film may be any type as long as it exhibits insulating properties. For example, when the covering insulating film contains a resin, the resin may be either a thermosetting resin or a thermoplastic resin. Although not particularly limited, examples of the specific resin material of the covering insulating film include an epoxy-based resin, a silicone-based resin, and/or a liquid crystal polymer. Although it is merely an example, a thickness of the covering insulating film may be 30 μm to 1000 μm, and is, for example, 50 μm to 300 μm.

Note that, in the solid state battery, the covering insulating film is not essential, and a solid state battery in which the covering insulating film is not provided is also conceivable.

(Covering Inorganic Film)

Moreover, the solid state battery may be provided with the covering inorganic film 50 that covers the covering insulating film 30. As illustrated in FIGS. 1(A) and 1(B), since the covering inorganic film is positioned on the covering insulating film, the covering inorganic film largely encloses the solid state battery laminate on the support board as a whole together with the covering insulating film.

The covering inorganic film preferably has a thin film form. A material of the covering inorganic film is not particularly limited as long as it contributes to the inorganic film having a thin film form, and may be metal, glass, oxide ceramics, a mixture thereof, or the like. In a preferred aspect, the covering inorganic film contains a metal component. That is, the covering inorganic film is preferably a metal thin film. Although it is merely an example, a thickness of such a covering inorganic film may be 0.1 μm to 100 μm, and is, for example, 1 μm to 50 μm.

In particular, depending on a manufacturing method, the covering inorganic film 50 may be a dry plating film. Such a dry plating film is a film obtained by a vapor phase method such as physical vapor deposition (PVD) or chemical vapor deposition (CVD), and has a very small thickness on the nano order or the micron order. Such a thin dry plating film contributes to more compact packaging.

The dry plating film may include, for example, at least one metal component/metalloid component selected from the group consisting of aluminum (Al), nickel (Ni), palladium (Pd), silver (Ag), tin (Sn), gold (Au), copper (Cu), titanium (Ti), platinum (Pt), silicon (Si), SUS, and the like, an inorganic oxide, a glass component, and/or the like. Since the dry plating film including such a component is chemically and/or thermally stable, a solid state battery having excellent chemical resistance, weather resistance, heat resistance, and/or the like and further improved long-term reliability can be provided.

Note that in the solid state battery, the covering inorganic film is not essential, and a solid state battery in which the covering insulating film is not provided is also conceivable.

(Support Board)

The support board 10 is a board provided to support the solid state battery laminate 100. The support board is positioned on one side that forms a principal surface of the solid state battery so as to serve as the “support”. Furthermore, it preferably has a thin plate-like form as a whole because of the “board”.

The support board 10 may be, for example, a resin board or a ceramic board, and is preferably a board having water resistance. In a preferred aspect, the support board 10 is a ceramic board. That is, the support board 10 contains ceramic, and the ceramic occupies a base material component of the board. The support board made of ceramic contributes to prevention of water vapor transmission, and is a preferred board in terms of heat resistance and the like in board mounting. Such a ceramic board can be obtained through firing, and for example, can be obtained by firing a green sheet laminate. In this regard, the ceramic board may be, for example, a low temperature co-fired ceramics (LTCC) board or a high temperature co-fired ceramic (HTCC) board. Although it is merely an example, a thickness of the support board may be 20 μm to 1000 μm, and is, for example, 100 μm to 300 μm.

Furthermore, the support board 10 functions as a terminal board of the solid state battery laminate 100. That is, the solid state battery packaged in a form in which the board is interposed can be mounted on another secondary board such as a printed wiring board. For example, the solid state battery can be surface-mounted via the support board through solder reflow or the like. From the above, it can be said that the packaged solid state battery is an SMD type battery. In particular, when the terminal board includes a ceramic board, the solid state battery can be an SMD type battery having high heat resistance and being solder-mountable.

Because of the terminal board, it is preferable to include wiring, and in particular, it is preferable to include wiring 17 (see FIGS. 1(A) and 1(B)) that electrically connects upper and lower surfaces or upper and lower surface layers. That is, the support board of a preferred aspect includes the wiring that electrically connects the upper and lower surfaces of the board, and is a terminal board for an external terminal of the packaged solid state battery.

The wiring 17 in the terminal board is not particularly limited, and may have any form as long as it contributes to electrical connection between the upper surface and the lower surface of the board. Since it contributes to the electrical connection, it can be said that the wiring 17 in the terminal board is a conductive part of the board. The conductive part of such a board may have the form of wiring layers, vias and/or lands, etc. For example, in the aspect illustrated in FIGS. 1(A) and 1(B), vias 14 and/or lands 16 are provided in the support board 10. The “via” referred to herein refers to a member for electrically connecting an up-down direction of the support board, that is, a board thickness direction, and for example, a filled via or the like is preferable, and may be in the form of an inner via or the like. Furthermore, the term “land” as used in the present specification refers to a terminal part/connection part (preferably a terminal part/connection part connected to a via) for electrical connection provided on the upper principal surface and/or the lower principal surface of the support board, and may be, for example, a corner land or a round land.

[Features of Solid State Battery of Present Invention]

In the solid state battery of the present invention, a moisture absorbing material is mixed into a constituent element of a packaged solid state battery. Here, the phrase “a moisture absorbing material is mixed into a constituent element of a solid state battery” as used in the present specification means that a moisture absorbing material that absorbs moisture is contained in a member constituting the solid state battery, and the moisture absorbing material is mixed into the member. That is, since the moisture absorbing material that absorbs moisture is mixed into at least one or a plurality of the external terminals 150, the inactive substance part 170, the insulating outermost layer 160, the covering insulating film 30, and the support board 10, which are basic configurations in the solid state battery described above, the solid state battery is different from a conventionally known secondary battery in which a moisture absorbing member is separately provided or a conventionally known secondary battery in which a moisture absorbing material is added to a housing provided outside a constituent element of the battery. Note that examples of the aspect of mixing the moisture absorbing material include an aspect of uniformly mixing a moisture absorbent into the constituent elements and an aspect of locally unevenly mixing a moisture absorbent into the constituent elements.

The moisture absorbing material to be mixed contains a material that absorbs moisture, and examples thereof include at least one selected from the group consisting of synthetic zeolite, silica gel, phosphorus pentoxide, barium oxide, calcium oxide, and an organometallic structure. In particular, a moisture absorbing membrane mixed with the synthetic zeolite is suitable because the moisture absorbing membrane is a material that has good temperature resistance and does not deliquesce when heat is generated by the operation of the solid state battery and the synthetic zeolite becomes high temperature, and has a good suction rate per unit weight. Note that the moisture absorbing material to be mixed may be a moisture absorbing material obtained by combining two or more kinds of moisture absorbents. Furthermore, as the moisture absorbing material, a powdery material may be used, or a solid material may be obtained by aggregation.

Hereinafter, an embodiment in which a moisture absorbing material is mixed into each basic configuration in the solid state battery will be described.

<Embodiment in which Moisture Absorbing Material is Mixed into External Terminal>

In one embodiment of the present invention, a moisture absorbing material is mixed into the external terminals 150 (see FIG. 1(a)). Specifically, a moisture absorbing material is mixed into a metal paste constituting the external terminals. Note that, in the drawing, a moisture absorbing material is mixed into hatched members (external terminals 150). As described above, the moisture absorbing material is preferably synthetic zeolite. The content of the moisture absorbing material is preferably set to such an extent that the function (for example, conductivity and the like) of the external terminals is not impaired, and will be described in detail in Examples described later, but is preferably 1 vol % to 25 vol % based on whole external terminals. Note that as another embodiment of the solid state battery illustrated in FIG. 1(a), the inactive substance part 170 may be provided as illustrated in FIG. 1(b). Furthermore, as another embodiment, although not illustrated, a top surface and a bottom surface of the solid state battery laminate may be the laminated part 140 without providing the insulating outermost layer 160.

Here, in a conventionally known solid state battery laminate, since an electrode material such as an external terminal is exposed on a side surface located in a direction intersecting the lamination direction, moisture may enter from the external terminal or the vicinity of the external terminal to cause deterioration of the solid state battery. Therefore, in the embodiment of the present invention, the moisture absorbing material is mixed into the external terminals. According to such an embodiment, moisture is absorbed by the moisture absorbing material mixed into the external terminals, so that entry of moisture into the solid state battery laminate can be reduced.

Moreover, in the present embodiment, since the moisture absorbing material is mixed into the external terminals themselves, an increase in volume can be suppressed as compared with a case where a member having moisture absorbency is provided separately from the external terminals. Therefore, a decrease in energy density per volume of the solid state battery can be suppressed, and downsizing of the package can be realized.

<Embodiment in which Moisture Absorbing Material is Mixed into Inactive Substance Part 170>

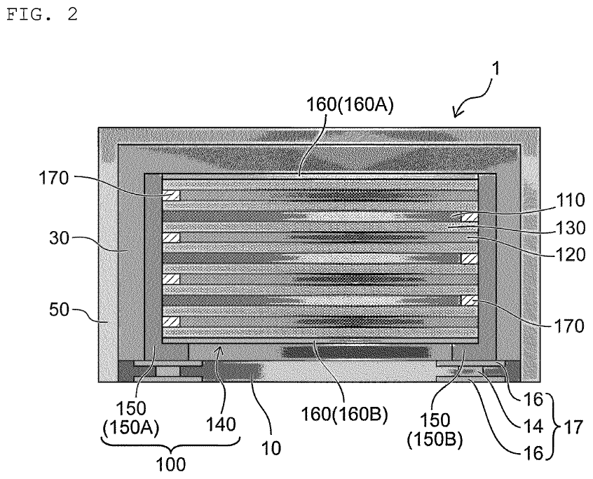

In another embodiment of the present invention, a moisture absorbing material may be mixed into the inactive substance part 170 (see FIG. 2). Specifically, the moisture absorbing material is mixed into an insulating sintered body constituting the inactive substance part 170. Note that in the drawing, the moisture absorbing material is mixed into a hatched member (the inactive substance part 170). As described above, the moisture absorbing material is preferably synthetic zeolite. A content of the moisture absorbing material is preferably set to such an extent that the function (for example, insulating properties, covering properties, and the like) of the inactive substance part is not impaired, and will be described in detail in Examples described later, but is preferably 1 vol % to 80 vol % based on a whole inactive substance part. Note that as another embodiment, although not illustrated, the top surface and the bottom surface of the solid state battery laminate may be the laminated part 140 without providing the insulating outermost layer 160.

In the present embodiment, the moisture absorbing material can absorb moisture entering at a position closer to the solid state battery laminate by mixing the moisture absorbing material with the inactive substance part included in a part of the laminated part. Therefore, entry of moisture into the solid state battery can be more effectively suppressed.

<Embodiment in which Moisture Absorbing Material is Mixed into Insulating Outermost Layer 160>

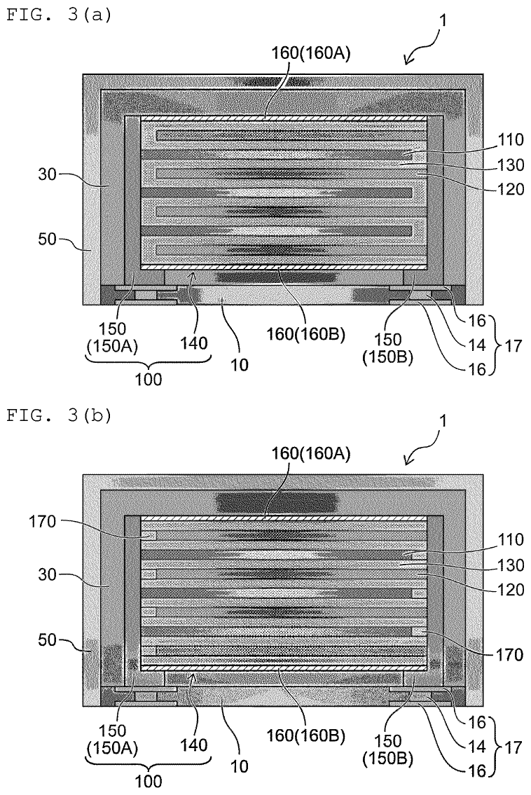

In another embodiment of the present invention, a moisture absorbing material may be mixed into the insulating outermost layer 160 (see FIGS. 3(a) and 3(b)). Specifically, the moisture absorbing material is mixed into a resin material or a sintered material constituting the insulating outermost layer 160. Note that in the drawing, the moisture absorbing material is mixed in a hatched member (the insulating outermost layer 160). As described above, the moisture absorbing material is preferably synthetic zeolite. A content of the moisture absorbing material is preferably set to such an extent that the function (for example, insulating properties, covering properties, and the like) of the insulating outermost layer is not impaired, and will be described in detail in Examples described later, but is preferably 1 vol % to 80 vol % based on a whole insulating outermost layer. Note that as another embodiment of the solid state battery illustrated in FIG. 3(a), the inactive substance part 170 as illustrated in FIG. 3(b) may be provided.

In the present embodiment, by mixing the moisture absorbing material into the insulating outermost layers on the upper surface and the lower surface of the laminated part, it is possible to reduce unexpected moisture ingress from the lamination direction (vertical direction).

<Embodiment in which Moisture Absorbing Material is Mixed into Covering Insulating Film 30>

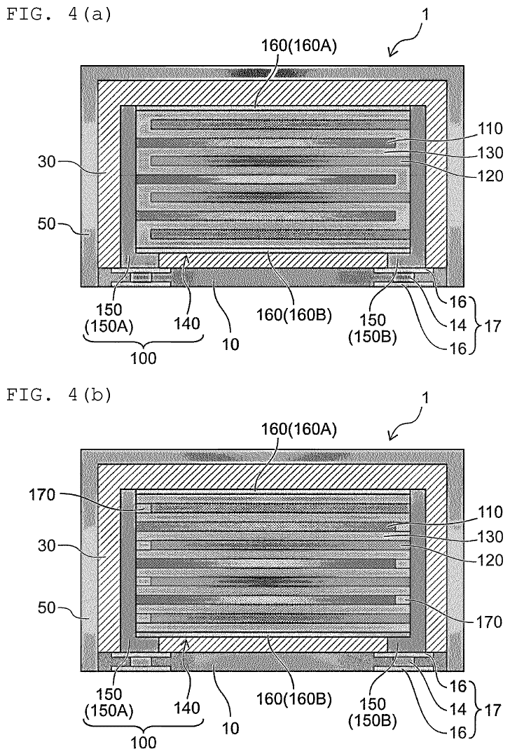

In another embodiment of the present invention, a moisture absorbing material may be mixed into the covering insulating film 30 (FIGS. 4(a) and 4(b)). Specifically, the moisture absorbing material is mixed into a resin material constituting the covering insulating film. Note that in the drawing, the moisture absorbing material is mixed in a hatched member (the covering insulating film 30). As described above, the moisture absorbing material is preferably synthetic zeolite. A content of the moisture absorbing material is preferably set to such an extent that the function (for example, insulating properties, covering properties, and the like) of the covering insulating film 30 is not impaired, and will be described in detail in Examples described later, but is preferably 1 vol % to 45 vol % based on a whole covering insulating film. Note that, as another embodiment of the solid state battery illustrated in FIG. 4(a), the inactive substance part 170 as illustrated in FIG. 4(b) may be provided. Furthermore, as another embodiment, although not illustrated, a top surface and a bottom surface of the solid state battery laminate may be the laminated part 140 without providing the insulating outermost layer 160.

In the present embodiment, since the covering insulating film mixed with the moisture absorbing material is provided so as to cover the solid state battery laminate, moisture that enters the solid state battery from substantially all directions can be absorbed.

<Embodiment in which Moisture Absorbing Material is Mixed into Support Board 10>

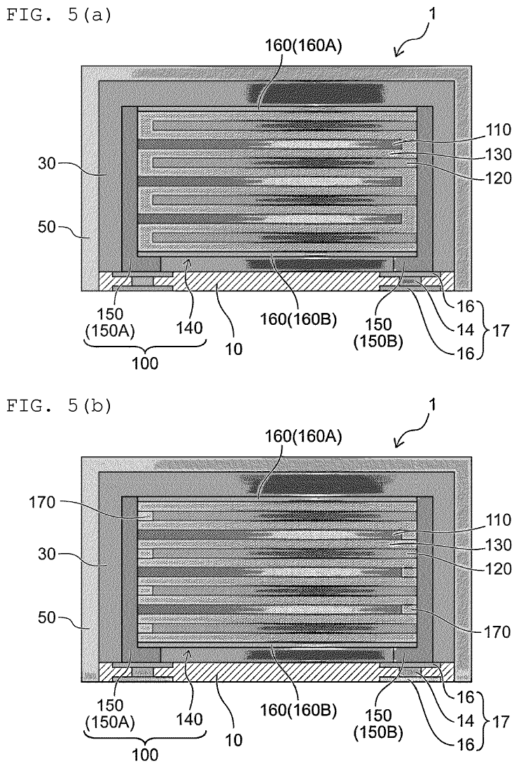

In another embodiment of the present invention, a moisture absorbing material may be mixed into the support board 10. Specifically, the moisture absorbing material is mixed into a base material constituting the support board. Note that FIGS. 5(a) and 5(b) illustrate a hatched member (the support board 10) mixed with the moisture absorbing material. As described above, the moisture absorbing material is preferably synthetic zeolite. A content of the moisture absorbing material is preferably set to such an extent that the function (for example, durability, water resistance, and the like) of the support board is not impaired, and will be described in detail in Examples described later, but is preferably 1 vol % to 45 vol % based on a whole support board. Note that, as another embodiment of the solid state battery illustrated in FIG. 5(a), the inactive substance part 170 as illustrated in FIG. 5(b) may be provided. Furthermore, as another embodiment, although not illustrated, a top surface and a bottom surface of the solid state battery laminate may be the laminated part 140 without providing the insulating outermost layer 160.

In the present embodiment, the moisture absorbing material is mixed into the support board that supports the solid state battery laminate, so that entry of moisture into the solid state battery can be prevented.

Note that the reference time of the content of the moisture absorbing material described above based on the whole external terminal, based on the whole inactive substance part, based on the whole insulating outermost layer, based on the whole covering insulating film, and based on the whole supporting board may be the completion time point of the solid state battery.

<Other Embodiment 1>

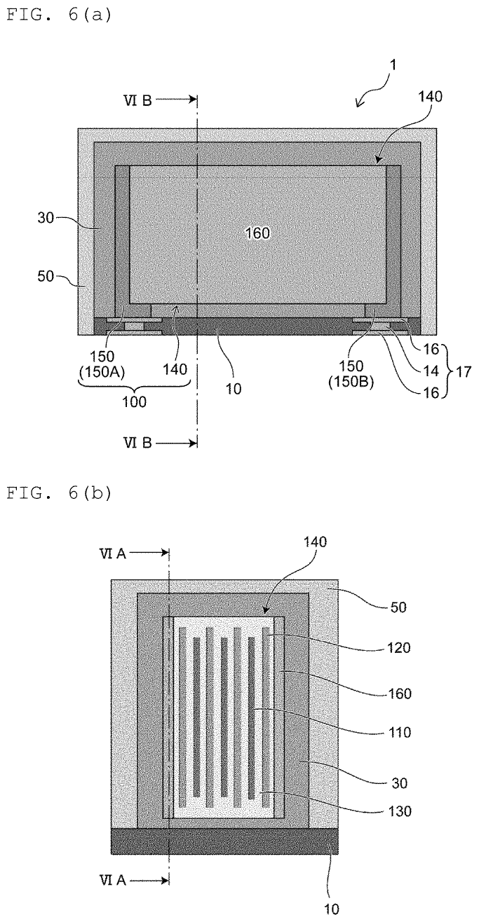

Another embodiment will be described with reference to FIGS. 6(a) and 6(b). This will be described with reference to FIGS. 6(a) and 6(b). FIG. 6(a) is a side sectional view schematically illustrating a configuration of a solid state battery according to another embodiment of the present invention (VIA-VIA sectional view of FIG. 6(b)), and FIG. 6(b) is a VIB-VIB sectional view of FIG. 6(a). As in the present embodiment, the solid state battery laminate may be supported by the support board such that the lamination direction of the laminated part 140 and the support surface of the support board 10 are parallel to each other (see FIG. 6(b)). The member mixed with the moisture absorbing material may have a configuration of one or more of an external terminal, an inactive substance part, an insulating outermost layer, a covering insulating film, and a support board. Also in such an embodiment, since moisture is absorbed by the constituent element mixed with the moisture absorbing material, entry of moisture into the solid state battery can be reduced. Furthermore, according to the present embodiment, in a case where expansion occurs in the lamination direction due to charge and discharge or the like, deformation or the like of the support board due to the expansion can be reduced. Note that the term “parallel” used in the present specification is not limited to a perfectly parallel state, and includes a substantially parallel state.

<Other Embodiment 2>

In the description of the above embodiment, the embodiment in which the moisture absorbing material that absorbs moisture is mixed into one configuration of the external terminal, the inactive substance part, the insulating outermost layer, the covering insulating film, and the support board has been described, but the present invention is not limited to this example, and the moisture absorbing material may be mixed into a plurality of configurations (two or more or all). Specific embodiments include an aspect in which the moisture absorbing material is mixed into the external terminal and the inactive substance part, an aspect in which the moisture absorbing material is mixed into the external terminal and the insulating outermost layer, an aspect in which the moisture absorbing material is mixed into the external terminal and the covering insulating film, an aspect in which the moisture absorbing material is mixed into the external terminal and the support board, an aspect in which the moisture absorbing material is mixed into the inactive substance part and the insulating outermost layer, an aspect in which the moisture absorbing material is mixed into the inactive substance part and the covering insulating film, an aspect in which the moisture absorbing material is mixed into the inactive substance part and the support board, an aspect in which the moisture absorbing material is mixed into the insulating outermost layer and the covering insulating film, an aspect in which the moisture absorbing material is mixed into the insulating outermost layer and the support board, an aspect in which the moisture absorbing material is mixed into the covering insulating film and the support board, an aspect in which the moisture absorbing material is mixed into the external terminal, the inactive substance part and the insulating outermost layer, an aspect in which the moisture absorbing material is mixed into the external terminal, the inactive substance part, and the covering insulating film, an aspect in which the moisture absorbing material is mixed into the external terminal, the inactive substance part, and the support board, an aspect in which the moisture absorbing material is mixed into the external terminal, the insulating outermost layer, and the covering insulating film, an aspect in which the moisture absorbing material is mixed into the external terminal, the insulating outermost layer, and the support board, an aspect in which the moisture absorbing material is mixed into the external terminal, the covering insulating film, and the support board, an aspect in which the moisture absorbing material is mixed into the inactive substance part, the insulating outermost layer, and the covering insulating film, an aspect in which the moisture absorbing material is mixed into the inactive substance part, the insulating outermost layer, and the support board, an aspect in which the moisture absorbing material is mixed into the inactive substance part, the covering insulating film, and the support board, an aspect in which the moisture absorbing material is mixed into the insulating outermost layer, the covering insulating film, and the support board, an aspect in which the moisture absorbing material is mixed into the external terminal, the inactive substance part, the insulating outermost layer, and the covering insulating film, an aspect in which the moisture absorbing material is mixed into the external terminal, the inactive substance part, the insulating outermost layer, and the support board, an aspect in which the moisture absorbing material is mixed into the external terminal, the inactive substance part, the insulating outermost layer, and the support board, an aspect in which the moisture absorbing material is mixed into the external terminal, the inactive substance part, the covering insulating film, and the support board, an aspect in which the moisture absorbing material is mixed into the external terminal, the covering insulating film, the insulating outermost layer, and the support board, and an aspect in which the moisture absorbing material is mixed into the inactive substance part, the covering insulating film, the insulating outermost layer, and the support board.

[Method of Manufacturing Solid State Battery Package of Present Invention]

The object of the present invention can be obtained by preparing a solid state battery containing a battery constituent unit having a positive electrode layer, a negative electrode layer, and a solid electrolyte between the electrodes, and then passing through a process of packaging the solid state battery.

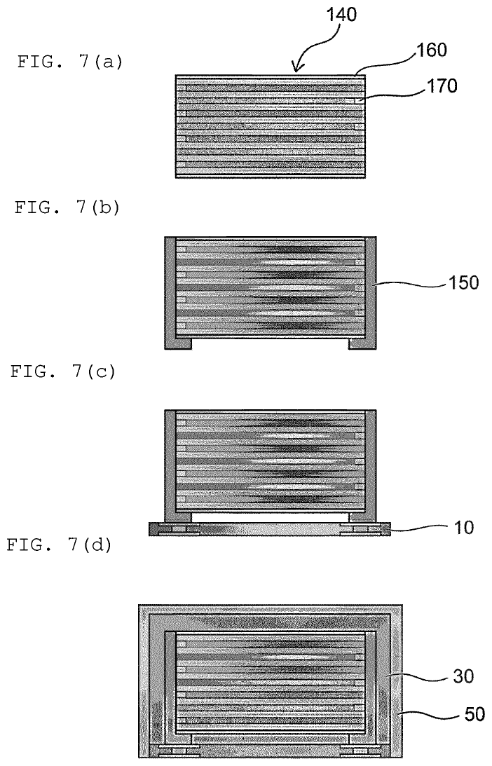

As illustrated in FIG. 7, the solid state battery of the present invention is manufactured through processes including manufacturing of the laminated part 140 (FIG. 7(a)), formation of the external terminal 150 (FIG. 7(b)), fixation to the support board 10 (FIG. 7(c)), and formation of the covering insulating film 30 and the covering inorganic film 50 (FIG. 7(d)). Hereinafter, description will be made in order.

<Manufacturing of Laminated Part>

The laminated part 140 can be manufactured by a printing method such as a screen printing method, a green sheet method using a green sheet, or a composite method thereof. That is, the laminated part itself may be manufactured according to a conventional solid state battery manufacturing method (Therefore, as raw material substances such as a solid electrolyte, an organic binder, a solvent, an optional additive, a positive electrode active material, and a negative electrode active material described below, those used in the production of known solid batteries may be used.).

Hereinafter, for better understanding of the present invention, one manufacturing method will be exemplified and described, but the present invention is not limited thereto. Furthermore, temporal matters such as the following description order are merely for convenience of description, and are not necessarily limited thereto.

First, a solid electrolyte, an organic binder, a solvent, and an optional additive are mixed to prepare a slurry. Subsequently, a sheet having a thickness of about 10 μm after firing is obtained from the prepared slurry by sheet forming. Next, a positive electrode active material, a solid electrolyte, a conductive material, an organic binder, a solvent, and an optional additive are mixed to prepare a positive electrode paste. Similarly, a negative electrode active material, a solid electrolyte, a conductive material, an organic binder, a solvent, and an optional additive are mixed to prepare a negative electrode paste. Then, the positive electrode paste is printed on the sheet, and a current collecting layer and/or an inactive substance part is printed as necessary.

Here, in the case of manufacturing a solid state battery in which a moisture absorbing material is mixed into the inactive substance part 170, the moisture absorbing material is mixed into the paste of the inactive substance part. The moisture absorbing material is preferably synthetic zeolite, and the content thereof is preferably 1 vol % to 80 vol % based on the whole inactive substance part.

Similarly, the negative electrode paste is printed on the sheet, and a current collecting layer and/or an inactive substance part is printed as necessary. In the case of manufacturing a solid state battery in which a moisture absorbing material is mixed into the inactive substance part 170, the moisture absorbing material is mixed into the paste of the inactive substance part.

Thereafter, the sheet on which the positive electrode paste is printed and the sheet on which the negative electrode paste is printed are alternately laminated to obtain a laminate. In an uppermost layer and/or a lowermost layer of the laminate, an insulating outermost layer which is an electrolyte layer or an insulating layer is provided for protecting the solid state battery.

In the case of manufacturing a solid state battery in which a moisture absorbing material is mixed into the insulating outermost layer 160, the moisture absorbing material is mixed into a paste of an electrolyte layer or an insulating layer constituting the insulating outermost layer. The moisture absorbing material is preferably synthetic zeolite, and the content thereof is preferably 1 vol % to 80 vol % based on the whole insulating outermost layer.

After the laminate is pressure-bonded and integrated, the laminate is cut into a predetermined size. The resulting cut laminate is subjected to degreasing and firing. Thus, a sintered laminate (laminated part 140) is obtained. Note that the laminate may be subjected to degreasing and firing before cutting, and then cut

<Formation of External Terminal>

The external terminal on the positive electrode side can be formed by applying a conductive paste to a positive electrode exposed side surface of the laminated part 140. Similarly, the external terminal on the negative electrode side can be formed by applying a conductive paste to a negative electrode exposed side surface of the laminated part 140.

In the case of manufacturing a solid state battery in which a moisture absorbing material is mixed into the external terminal 150, a desired moisture absorbing material is mixed into a conductive paste to be the external terminal 150. The moisture absorbing material is preferably synthetic zeolite, and the content thereof is preferably 1 vol % to 25 vol % based on the whole external terminal.

When the external terminals 150 on the positive electrode side and the negative electrode side are provided so as to extend to the lower surface of the sintered laminate, the external terminals can be connected to a mounting land in a small area in the next step, which is preferable (More specifically, the external terminal provided so as to extend to the lower surface of the sintered laminate has a folded part on the lower surface, and such a folded part can be electrically connected to the mounting land.). The component of the external terminal may be selected from at least one selected from silver, gold, platinum, aluminum, copper, tin, and nickel.

Note that the external terminals on the positive electrode side and the negative electrode side are not limited to be formed after sintering of the laminate, and may be formed before firing and subjected to simultaneous sintering.

<Fixation to Support Board>

The support board 10 is provided with vias and/or lands to enable surface mounting on the secondary board. For example, it can be obtained by laminating and firing a plurality of green sheets. This is particularly true when the support board is a ceramic board. The preparation of the support board can be performed, for example, in accordance with the preparation of the LTCC board.

In the case of manufacturing a solid state battery in which a moisture absorbing material is mixed into the support board 10, the moisture absorbing material is mixed into a base material serving as the support board. The moisture absorbing material is preferably synthetic zeolite, and the content thereof is preferably 1 vol % to 45 vol % based on the whole support board.

The via and/or the land in the support board is manufactured by, for example, a method of forming a hole (diameter size: about 50 μm to 200 μm) by a punch press, a carbon dioxide laser, or the like and filling the hole with a conductive paste material, or a method using a printing method.

After the support board 10 is manufactured, the solid state battery laminate 100 is disposed on the support board 10 so that the conductive part of the support board 10 and the external terminal 150 of the solid state battery laminate 100 are electrically connected to each other. Then, the conductive paste may be provided on the support board 10 so that the conductive part of the support board 10 and the external terminal 150 of the solid state battery laminate 100 are electrically connected to each other. As the conductive paste, in addition to the Ag conductive paste, a conductive paste that does not require washing such as a flux after formation, such as a nano paste, an alloy-based paste, or a brazing material, can be used.

<Formation of Covering Insulating Film and Covering Inorganic Film>

Subsequently, the covering insulating film 30 is formed so as to cover the solid state battery laminate 100 on the support board 10. Therefore, a raw material of the covering insulating film 30 is provided so that the solid state battery laminate 100 on the support board 10 is wholly covered. When the covering insulating film 30 is made of a resin material, a resin precursor is provided on the support board 10 and cured to mold the covering insulating film 30.

In the case of manufacturing a solid state battery in which a moisture absorbing material is mixed into the covering insulating film 30, the moisture absorbing material is mixed into a resin material to be the covering insulating film 30. The moisture absorbing material is preferably synthetic zeolite, and the content thereof is preferably 1 vol % to 45 vol % based on the whole covering insulating film.

In a preferred aspect, the covering insulating film 30 may be molded by applying pressure with a mold. Although it is merely an example, the covering insulating film 30 for sealing the solid state battery laminate 100 on the support board 10 may be molded through compression molding. In the case of a resin material generally used in a mold, the form of the raw material of the covering insulating film may be granular, and the type thereof may be thermoplastic. Note that such molding is not limited to die molding, and may be performed through polishing, laser processing, and/or chemical treatment.

Next, the covering inorganic film 50 is formed. For the covering inorganic film 50, for example, dry plating may be performed, and a dry plating film may be used as the covering inorganic film. More specifically, dry plating is performed to form the covering inorganic film 50 on the exposed surface other than the bottom surface of the covering precursor (that is, other than the bottom surface of the support board). In a preferred aspect, sputtering is performed to form a sputtered film on the exposed outer surface other than the bottom surface of the covering precursor.

Through the above steps, the solid state battery package according to the present invention can be finally obtained. Note that the step of mixing the moisture absorbing material described above is preferably performed in a dry atmosphere in order to prevent moisture absorption during mixing of the moisture absorbing material. Furthermore, also in the step after mixing the moisture absorbing film, it is preferable to perform the step under a dry atmosphere in order to prevent the moisture absorbing material from absorbing moisture.

### EXAMPLES

### First Example

A first example related to the present invention will be described. The first example is particularly an example of a solid state battery in which a moisture absorbent is mixed into an external terminal (FIG. 1(a)), a solid state battery in which a moisture absorbent is mixed into a covering resin film (FIG. 4(a)), a solid state battery in which a moisture absorbent is mixed into a support board (FIG. 5(a)), and a solid state battery in which a moisture absorbent is mixed into all of an external terminal, a covering resin film, and a support board.

The solid batteries of Examples 1-1 to 1-14 and Comparative Examples described below were subjected to a demonstration test.

### Example 1-1

Solid state battery: solid state battery illustrated in FIG. 1(a)
Moisture absorbing material type: synthetic zeolite

(Zeoram (registered trademark) A-5 manufactured by Tosoh Corporation)
Volume fraction of moisture absorbing material: 1 wt % based on the whole external terminal

### Example 1-2

Solid state battery: solid state battery illustrated in FIG. 1(a)
Moisture absorbing material type: synthetic zeolite
Volume fraction of moisture absorbing material: 5 wt % based on the whole external terminal

### Example 1-3

Solid state battery: solid state battery illustrated in FIG. 1(a)
Moisture absorbing material type: synthetic zeolite
Volume fraction of moisture absorbing material: 20 wt % based on the whole external terminal

### Example 1-4

Solid state battery: solid state battery illustrated in FIG. 1(a)
Moisture absorbing material type: silica gel (TOYOTA KAKO CO., LTD., TOYOTA Silica Gel Type A)
Volume fraction of moisture absorbing material: 5 wt % based on the whole external terminal

### Example 1-5

Solid state battery: solid state battery illustrated in FIG. 4(a)
Moisture absorbing material type: synthetic zeolite
Volume fraction of moisture absorbing material: 1 wt % based on the whole covering resin film

### Example 1-6

Solid state battery: solid state battery illustrated in FIG. 4(a)
Moisture absorbing material type: synthetic zeolite
Volume fraction of moisture absorbing material: 10 wt % based on the whole covering resin film

### Example 1-7

Solid state battery: solid state battery illustrated in FIG. 4(a)
Moisture absorbing material type: synthetic zeolite
Volume fraction of moisture absorbing material: 40 wt % based on the whole covering resin film

### Example 1-8

Solid state battery: solid state battery illustrated in FIG. 4(a)
Moisture absorbing material type: silica gel
Volume fraction of moisture absorbing material: 10 wt % based on the whole covering resin film

### Example 1-9

Solid state battery: solid state battery illustrated in FIG. 5(a)
Moisture absorbing material type: synthetic zeolite
Volume fraction of moisture absorbing material: 1 wt % based on the whole support board

### Example 1-10

Solid state battery: solid state battery illustrated in FIG. 5(a)
Moisture absorbing material type: synthetic zeolite
Volume fraction of moisture absorbing material: 10 wt % based on the whole support board

### Example 1-11

Solid state battery: solid state battery illustrated in FIG. 5(a)
Moisture absorbing material type: synthetic zeolite
Volume fraction of moisture absorbing material: 40 wt % based on the whole support board

### Example 1-12

Solid state battery: solid state battery illustrated in FIG. 5(a)
Moisture absorbing material type: silica gel
Volume fraction of moisture absorbing material: 10 wt % based on the whole support board

### Example 1-13

Solid state battery: a solid state battery in which a moisture absorbent is mixed in all of the external terminal, the covering resin film, and the support board
Moisture absorbing material type: synthetic zeolite
Volume fraction of moisture absorbing material: 5 wt % based on each component

### Example 1-14

Solid state battery: a solid state battery in which a moisture absorbent is mixed in all of the external terminal, the covering resin film, and the support board
Moisture absorbing material type: silica gel
Volume fraction of moisture absorbing material: 5 wt % based on each component

### Comparative Example

Solid state battery: a solid state battery in which a conventionally known moisture absorbent is not mixed

As the contents of the demonstration test, for the solid batteries of Examples 1-1 to 1-14 and Comparative Example, the solid state battery in which the covering inorganic film 50 was not formed was stored at 23° C. under an environment of a relative humidity of 20% (dew point of about 0° C.) for 1 week, and a rate of change between the discharge capacity change after storage and the discharge capacity change before storage was confirmed. Note that for the calculation of the change in discharge capacity, a method of checking a change in discharge capacity when the battery is charged up to 4.2 V and then discharged up to 2.0 V by the charge and discharge device was adopted. Furthermore, the above demonstration test was performed on a solid state battery not provided with a covering inorganic film in order to perform the test in a state in which moisture relatively easily enters the solid state battery. The results of the demonstration test are illustrated in Table 1 below.

TABLE 1

| | | Volume fraction of | | |
|---|---|---|---|---|
| | Moisture absorbing | moisture absorbing | Part containing moisture | |
| | material type | material (Vol %) | absorbing material | Decision |
| Example 1-1 | Synthetic zeolite | 1 | External terminal | ◯ |
| Example 1-2 | Synthetic zeolite | 5 | External terminal | ⊙ |
| Example 1-3 | Synthetic zeolite | 20 | External terminal | ⊙ |
| Example 1-4 | Silica gel | 5 | External terminal | ⊙ |
| Example 1-5 | Synthetic zeolite | 1 | Covering resin film | ◯ |
| Example 1-6 | Synthetic zeolite | 10 | Covering resin film | ⊙ |
| Example 1-7 | Synthetic zeolite | 40 | Covering resin film | ⊙ |
| Example 1-8 | Silica gel | 10 | Covering resin film | ⊙ |
| Example 1-9 | Synthetic zeolite | 1 | Support board | ◯ |
| Example 1-10 | Synthetic zeolite | 10 | Support board | ◯ |
| Example 1-11 | Synthetic zeolite | 40 | Support board | ◯ |
| Example 1-12 | Silica gel | 10 | Support board | ◯ |
| Example 1-13 | Synthetic zeolite | 5 | External terminal + | ⊙⊙ |
| | | | covering resin film + | |
| | | | support board | |
| Example 1-14 | Silica gel | 5 | External terminal + | ⊙⊙ |
| | | | covering resin film + | |
| | | | support board | |
| Comparative | — | — | — | X |
| example | | | | |

From the above demonstration test results, when the volume fraction of the moisture absorbing material mixed in the external terminal was 1 vol % to 20 vol % based on the whole external terminal, the rate of change in discharge capacity was better than that in Comparative Example. Note that an upper limit of the volume fraction may be 20 vol % or more as long as the function (for example, conductivity and the like) of the external terminal is not affected.

Furthermore, when the volume fraction of the moisture absorbing material mixed in the covering resin film was 1 vol % to 40 vol % based on the whole covering resin film, the rate of change in discharge capacity was better than that in Comparative Example. Note that an upper limit of the volume fraction may be 40 vol % or more as long as it does not affect the function (for example, insulating properties, covering properties, and the like) of the covering resin film.

Furthermore, when the volume fraction of the moisture absorbing material mixed in the support board was 1 vol % to 40 vol % based on the whole support board, the rate of change in discharge capacity was better than that in Comparative Example. Note that an upper limit of the volume fraction may be 40 vol % or more as long as it does not affect the function (for example, durability, water resistance, or the like) of the support board.

Furthermore, when a moisture absorbent was mixed in all of the external terminal, the covering resin film, and the support board, the rate of change in discharge capacity was very good when the volume fraction was about 5% based on each component.

### Second Example

A second example related to the present invention will be described. The second example is an example particularly for a solid state battery in which a moisture absorbent is mixed into the inactive substance part (FIG. 2), a solid state battery in which a moisture absorbent is mixed into the insulating outermost layer (FIG. 3(a)), and a solid state battery in which a moisture absorbent is mixed into both the inactive substance part and the insulating outermost layer.

The following solid batteries of Examples 2-1 to 2-13 and Comparative Examples were subjected to a demonstration test.

### Example 2-1

Solid state battery: solid state battery illustrated in FIG. 2
Moisture absorbing material type: synthetic zeolite
Volume fraction of moisture absorbing material: 1 wt % based on the whole inactive substance part

### Example 2-2

Solid state battery: solid state battery illustrated in FIG. 2
Moisture absorbing material type: synthetic zeolite
Volume fraction of hygroscopic material: 40 wt % based on the whole inactive substance part

### Example 2-3

Solid state battery: solid state battery illustrated in FIG. 2
Moisture absorbing material type: synthetic zeolite
Volume fraction of hygroscopic material: 20 wt % based on the whole inactive substance part

### Example 2-4

Solid state battery: solid state battery illustrated in FIG. 2
Moisture absorbing material type: synthetic zeolite
Volume fraction of hygroscopic material: 74 wt % based on the whole inactive substance part

### Example 2-5

Solid state battery: solid state battery illustrated in FIG. 2
Moisture absorbing material type: silica gel
Volume fraction of hygroscopic material: 40 wt % based on the whole inactive substance part

### Example 2-6

Solid state battery: solid state battery illustrated in FIG. 2
Moisture absorbing material type: synthetic zeolite
Volume fraction of moisture absorbing material: 30 wt % based on the whole inactive substance part

### Example 2-7

Solid state battery: solid state battery illustrated in FIG. 3(a)
Moisture absorbing material type: synthetic zeolite
Volume fraction of moisture absorbing material: 1 wt % based on the whole insulating outermost layer

### Example 2-8

Solid state battery: solid state battery illustrated in FIG. 3(a)
Moisture absorbing material type: synthetic zeolite
Volume fraction of moisture absorbing material: 40 wt % based on the whole insulating outermost layer

### Example 2-9

Solid state battery: solid state battery illustrated in FIG. 3(a)
Moisture absorbing material type: synthetic zeolite
Volume fraction of moisture absorbing material: 20 wt % based on the whole insulating outermost layer

### Example 2-10

Solid state battery: solid state battery illustrated in FIG. 3(a)
Moisture absorbing material type: synthetic zeolite
Volume fraction of moisture absorbing material: 74 wt % based on the whole insulating outermost layer

### Example 2-11

Solid state battery: solid state battery illustrated in FIG. 3(a)
Moisture absorbing material type: synthetic zeolite
Volume fraction of moisture absorbing material: 40 wt % based on the whole insulating outermost layer

### Example 2-12

Solid state battery: solid state battery illustrated in FIG. 3(a)
Moisture absorbing material type: synthetic zeolite
Volume fraction of moisture absorbing material: 30 wt % based on the whole insulating outermost layer

### Example 2-13

Solid state battery: a solid state battery in which a moisture absorbent is mixed in both an inactive substance part and an insulating outermost layer
Moisture absorbing material type: synthetic zeolite
Volume fraction of moisture absorbing material: 30 wt % based on each component

### Comparative Example

Solid state battery: a solid state battery in which a conventionally known moisture absorbent is not mixed

For the contents of the demonstration test, the same method as the method described in the first example was adopted. The results of the demonstration test are illustrated in Table 2 below.

TABLE 2

| | | Volume fraction of | | |
|---|---|---|---|---|
| | Moisture absorbing | moisture absorbing | Part containing moisture | |
| | material type | material (Vol %) | absorbing material | Decision |
| Example 2-1 | Synthetic zeolite | 1 | Inactive substance part | ◯ |
| Example 2-2 | Synthetic zeolite | 40 | Inactive substance part | ◯ |
| Example 2-3 | Synthetic zeolite | 20 | Inactive substance part | ◯ |
| Example 2-4 | Synthetic zeolite | 74 | Inactive substance part | ◯ |
| Example 2-5 | Silica gel | 40 | Inactive substance part | ◯ |
| Example 2-6 | Synthetic zeolite | 30 | Inactive substance part | ⊙ |
| Example 2-7 | Synthetic zeolite | 1 | Insulating outermost layer | ◯ |
| Example 2-8 | Synthetic zeolite | 40 | Insulating outermost layer | ◯ |
| Example 2-9 | Synthetic zeolite | 20 | Insulating outermost layer | ◯ |
| Example 2-10 | Synthetic zeolite | 74 | Insulating outermost layer | ◯ |
| Example 2-11 | Silica gel | 40 | Insulating outermost layer | ◯ |
| Example 2-12 | Synthetic zeolite | 30 | Insulating outermost layer | ⊙ |
| Example 2-13 | Synthetic zeolite | 30 | Inactive substance part + | ⊙⊙ |
| | | | insulating outermost layer | |
| Comparative | — | — | — | X |
| example | | | | |

From the above demonstration test results, when the volume fraction of the moisture absorbing material mixed in the inactive substance part was 1 vol % to 74 vol % based on the whole inactive substance part, the rate of change in discharge capacity was good as compared with Comparative Example. In particular, when the volume fraction of the moisture absorbent was 30 vol %, the rate of change in discharge capacity was very good (see Example 2-6). Note that an upper limit of the volume fraction may be 74 vol % or more as long as it does not affect the function (for example, insulating properties, covering properties, and the like) of the inactive substance part.

Furthermore, when the volume fraction of the moisture absorbing material mixed in the insulating outermost layer was 1 vol % to 74 vol % based on the whole insulating outermost layer, the rate of change in discharge capacity was better than that in Comparative Example. In particular, when the volume fraction of the moisture absorbent was 30 vol %, the rate of change in discharge capacity was very good (see Example 2-12). Note that an upper limit of the volume fraction may be 74 vol % or more as long as it does not affect the function (for example, insulating properties, covering properties, and the like) of the covering resin film.

Furthermore, in the solid state battery in which the synthetic zeolite was mixed into both the inactive substance part and the insulating outermost layer, the rate of change in the discharge capacity of the solid state battery in which the contents of both were set to 30 vol % based on each constituent standard showed a particularly good result (see Example 2-13).

Note that the embodiments disclosed herein are illustrative in all respects, and do not provide a basis for restrictive interpretation. Therefore, the technical scope of the present invention is not to be construed only by the above-described embodiments, but is defined based on the description of the claims. Furthermore, the technical scope of the present invention includes meanings equivalent to the claims and all modifications within the scope. For example, the solid state battery may have a polyhedral shape, a cylindrical shape, or a spherical shape.

The packaged solid state battery of the present invention can be used in various fields where battery use or storage is assumed. By way of example only, the packaged solid state battery of the present invention can be used in the electronics packaging field. Furthermore, the present invention can also be used in electric, information, and communication fields (for example, electric and electronic equipment fields or mobile equipment fields including mobile phones, smartphones, notebook computers and digital cameras, activity meters, arm computers, electronic paper, RFID tags, card-type electronic money, small electronic machines such as smartwatches, and the like.) in which mobile devices and the like are used, home and small industrial applications (for example, the fields of electric tools, golf carts, and home, nursing, and industrial robots), large industrial applications (for example, fields of forklift, elevator, and harbor crane), transportation system fields (for example, the field of hybrid vehicles, electric vehicles, buses, trains, power-assisted bicycles, electric two-wheeled vehicles, and the like), power system applications (for example, fields such as various types of power generation, road conditioners, smart grids, and household power storage systems), medical applications (medical device fields such as earphone hearing aids), medical applications (fields such as dose management systems), IoT fields, space and deep sea applications (for example, fields such as a space probe and a submersible), and the like.

### DESCRIPTION OF REFERENCE SYMBOLS

1: Solid state battery
10: Support board
14: Via
16: Land
17: Wiring
30: Covering insulating film
50: Covering inorganic film
100: Solid state battery laminate
110: Positive electrode layer
120: Negative electrode layer
130: Solid electrolyte
140: Laminated part
150: External terminal
150A: External terminal on positive electrode side
150B: External terminal on negative electrode side
160: Insulating outermost layer
160A: Top surface of insulating outermost layer
160B: Bottom surface of insulating outermost layer
170: Inactive substance part

1. A solid state battery, comprising:
a solid state battery laminate including a positive electrode layer, a negative electrode layer, and a solid electrolyte layer interposed between the positive electrode layer and the negative electrode layer; and
a member surrounding or in contact with the solid state battery, the member containing a moisture absorbing material.

2. The solid state battery according to claim 1, wherein the member includes an inactive substance part forming at least a part of a side surface of the solid state battery laminate in a direction intersecting a direction of lamination thereof.

3. The solid state battery according to claim 1, wherein the member includes an insulating outermost layer surrounding at least a part of the solid state battery laminate.

4. The solid state battery according to claim 1, wherein the member includes an external terminal on a side surface of the solid state battery laminate.

5. The solid state battery according to claim 1, wherein the member includes a support board.

6. The solid state battery according to claim 1, further comprising a support board supporting the solid state battery laminate,
wherein a support surface of the support board and a lamination direction of the solid state battery laminate are parallel to each other.

7. The solid state battery according to claim 5, wherein the support board includes wiring that electrically connects an outermost surface of the board, and is a terminal board for an external terminal of the solid state battery.

8. The solid state battery according to claim 5, wherein the support board includes a wiring board including an inner via hole.

9. The solid state battery according to claim 1, wherein the member is a covering insulating film that covers the solid state battery laminate.

10. The solid state battery according to claim 1, wherein the member includes two or more of:
an inactive substance part that forms a part of a side surface of the solid state battery laminate in a direction intersecting a direction of lamination thereof;
an external terminal on a side surface of the solid state battery laminate;
an insulating outermost layer surrounding at least a part of the solid state battery laminate;
a covering insulating film that covers the solid state battery laminate; and
a support board that supports the solid state battery laminate.

11. The solid state battery according to claim 1, wherein the moisture absorbing material contains at least one selected from the group consisting of synthetic zeolite, silica gel, phosphorus pentoxide, barium oxide, calcium oxide, and an organometallic structure.

12. The solid state battery according to claim 11, wherein
the member is an inactive substance part that forms a part of a side surface of the solid state battery laminate in a direction intersecting a direction of lamination thereof and/or an insulating outermost layer surrounding at least a part of the solid state battery laminate,
the moisture absorbing material contains synthetic zeolite and/or silica gel, and
a content of at least one of the synthetic zeolite and/or the silica gel is 1 vol % to 80 vol % based on a whole of the inactive substance part and/or based on a whole of the insulating outermost layer.

13. The solid state battery according to claim 12, wherein the content is 20 vol % to 40 vol % based on the whole of the inactive substance part and/or based on the whole of the insulating outermost layer.

14. The solid state battery according to claim 11, wherein
the member is an external terminal on a side surface of the solid state battery laminate in a direction intersecting a direction of lamination thereof,
the moisture absorbing material contains synthetic zeolite and/or silica gel, and
a content of the synthetic zeolite and/or the silica gel is 1 vol % to 25 vol % based on a whole of the external terminal.

15. The solid state battery according to claim 11, wherein
the member is a covering insulating film covering the solid state battery laminate and/or a support board supporting the solid state battery laminate,
the moisture absorbing material contains synthetic zeolite and/or silica gel, and
a content of the synthetic zeolite and/or the silica gel is 1 vol % to 45 vol % based on a whole of the covering insulating film and/or based on a whole of the support board.

16. The solid state battery according to claim 1, wherein the solid state battery is packaged for surface mounting.

17. The solid state battery according to claim 1, wherein the solid state battery laminate is a sintered body.

18. The solid state battery according to claim 1, wherein the positive electrode layer and the negative electrode layer are layers capable of occluding and releasing lithium ions.
